(19) United States
(12) Patent Application Publication
(10) Pub. No.: US 2010/0051400 A1
(43) Pub. Date: Mar. 4, 2010

(54) Hydraulic brake lever device for bicycle

(75) Inventor: Falcon Yang, Taichung (TW)

Correspondence Address: CHARLES E. BAXLEY, ESQUIRE, 90 JOHN STREET, SUITE 309, NEW YORK, NY, 10038, US

(73) Assignee: Elf Performance System Co., Ltd.

(21) Appl. No.: 12/231,614

(22) Filed: Sep. 4, 2008

(51) Int. Cl. B60T 13/12

(52) U.S. Cl. 188/344

(57) ABSTRACT

A hydraulic brake lever device includes a cylinder housing for attaching to a handlebar of a bicycle and having a chamber for receiving a hydraulic oil and a piston and a spring member, a level handle has a block pivotally attached to the cylinder housing and having one end engageable with the cylinder housing, an actuating member is attached to the other end of the block for selectively forcing the piston onto the spring member, and an adjusting member threaded to the block and extendible out of the block for engaging with the cylinder housing and for adjusting the movement between the level handle and the handlebar and for allowing the level handle to be suitably operated by a user.

### BACKGROUND OF THE INVENTION

1. Field of the Invention

The present invention relates to a hydraulic brake lever device for a bicycle, and more particularly to a hydraulic brake lever device including an adjustable structure for adjusting the distance between the level handle of the hydraulic brake lever device and the handlebar of the bicycle, and for adjusting the braking to the bicycle, and for allowing the level handle of the hydraulic brake lever device to be suitably or comfortably grasped or gripped and operated by the user.

2. Description of the Prior Art

Typical hydraulic brake lever devices for bicycles comprise a hydraulic oil tank for receiving the hydraulic oil, the hydraulic oil tank includes a cylinder coupled or connected to the hydraulic oil tank, and a press rod is slidably mounted in the cylinder and coupled to a pull handle which may control the press rod to brake the bicycle.

For example, U.S. Pat. No. 6,883,647 to Wen discloses one of the typical hydraulic brake levers for the bicycles comprising a pull handle coupled to a press rod which is slidably mounted in a cylinder, and the pull handle includes a receiving groove formed therein for rotatably mounting an adjusting wheel.

However, the formation of the receiving groove in the pull handle may greatly reduce the strength of the pull handle such that the pull handle may have a good chance to be broken after use. In addition, it will be difficult to assemble the adjusting wheel into the receiving groove of the pull handle.

U.S. Pat. No. 7,204,350 to Lumpkin discloses another typical hydraulic disc brake levers for the bicycles also comprising a lever handle coupled to a hydraulic line with a number of parts or elements, and an adjustment knob attached to the hydraulic line for adjusting the connection between the lever handle and the hydraulic line.

However, a number of parts or elements are required to be manufactured and coupled or assembled between the lever handle and the hydraulic line such that the manufacturing and the assembling procedures are complicated and such that the manufacturing cost for the typical hydraulic disc brake levers may be greatly increased.

U.S. Pat. No. 7,389,642 to Takizawa et al. discloses a further typical hydraulic disc brake lever assembly for the bicycles comprising a lever coupled to first and second pistons contained in a master cylinder for providing a two-stage braking.

However, the two-stage braking structure for the typical hydraulic disc brake lever assembly is complicated and the manufacturing cost for the typical hydraulic disc brake lever may also be greatly increased.

The present invention has arisen to mitigate and/or obviate the afore-described disadvantages of the conventional hydraulic brake lever devices.

### SUMMARY OF THE INVENTION

The primary objective of the present invention is to provide a hydraulic brake lever device including an adjustable structure for adjusting the distance between the level handle of the hydraulic brake lever device and the handlebar of the bicycle, and for adjusting the braking to the bicycle, and for allowing the level handle of the hydraulic brake lever device to be suitably grasped or gripped and operated by the user.

The other objective of the present invention is to provide a hydraulic brake lever device including a simplified structure for allowing the hydraulic brake lever device to be easily manufactured and assembled.

In accordance with one aspect of the invention, there is provided a hydraulic brake lever device comprising a cylinder housing for attaching to a handlebar, and including a chamber formed therein for receiving a hydraulic oil and for coupling to a hydraulic line, and including a stop provided on the cylinder housing, a piston slidably received in the chamber of the cylinder housing and provided for forcing the hydraulic oil into the hydraulic line, a spring member received in the chamber of the cylinder housing and engaged between the cylinder housing and the piston for biasing the piston out of the chamber of the cylinder housing, a level handle including a block pivotally attached to the cylinder housing with a pivot axle for allowing the level handle to be pivoted relative to the cylinder housing and for allowing the level handle to be moved toward and away from the handlebar, the block including a first end and a second end, the first end of the block being engageable with the stop of the cylinder housing for determining a movement between the level handle and the handlebar, an actuating member attached to the second end of the block for engaging with the piston and for selectively moving and forcing the piston onto the hydraulic oil and the spring member, and an adjusting member threaded to the first end of the block and adjustably extended out of the first end of the block for engaging with the stop of the cylinder housing and for adjusting the movement between the level handle and the handlebar and for adjusting the braking to the bicycle, and for allowing the level handle of the hydraulic brake lever device to be suitably and comfortably grasped or gripped and operated by the user.

The level handle includes a cross dowel pivotally attached to the second end of the block for engaging with the actuating member. For example, the cross dowel includes a screw hole formed therein for threading and engaging with the actuating member and for allowing the actuating member to be rotated or adjusted relative to the cross dowel.

The block includes a compartment formed in the second end of the block and defined between two ears, the cross dowel is pivotally or rotatably attached to the ears and straddled between the ears and extended through the compartment of the block for threading and engaging with the actuating member.

The block includes a screw hole formed in the first end of the block for threading and engaging with the adjusting member and for allowing the adjusting member to be rotated or adjusted relative to the block and for allowing the adjusting member to be selectively extended out of the block.

The cylinder housing includes a space formed between two flaps and communicating with the chamber of the cylinder housing, the middle portion of the block of the level handle is pivotally or rotatably attached to the flaps of the cylinder housing with the pivot axle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a hydraulic brake lever device in accordance with the present invention;

FIG. 2 is a partial exploded view of the hydraulic brake lever device;

FIG. 3 is a partial cross sectional view of the hydraulic brake lever device taken along lines 3-3 of FIG. 1;

FIG. 4 is a partial cross sectional view similar to FIG. 3, illustrating the operation of the hydraulic brake lever device;

FIG. 5 is a partial perspective view similar to FIG. 1, illustrating the other arrangement of the hydraulic brake lever device;

FIG. 6 is a partial cross sectional view of the hydraulic brake lever device taken along lines 6-6 of FIG. 5;

FIG. 7 is a partial cross sectional view similar to FIG. 6, illustrating the operation of the hydraulic brake lever device as shown in FIGS. 5 and 6;

FIG. 8 is a partial exploded view similar to FIG. 2, illustrating the further arrangement of the hydraulic brake lever device; and

FIGS. 9, 10 are partial cross sectional views illustrating the operation of the hydraulic brake lever device as shown in FIG. 8.

### DETAILED DESCRIPTION OF THE PREFERRED EMBODIMENT

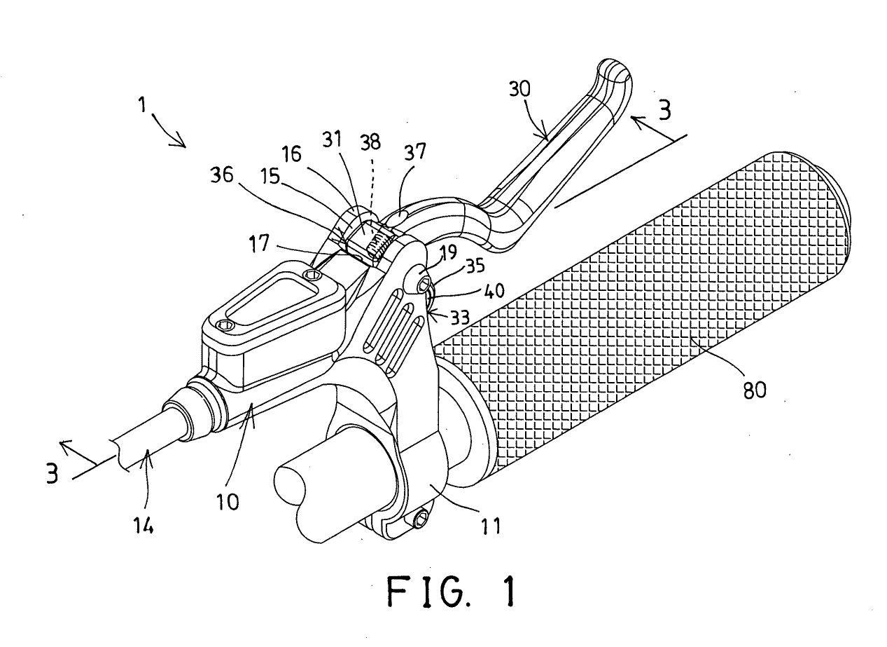

Referring to the drawings, and initially to FIGS. 1-3, a hydraulic brake lever device 1 in accordance with the present invention comprises a handlebar 80 of a typical bicycle (not shown), a cylinder housing 10 including a bar clamp 11 for attaching or securing to the handlebar 80, and including a chamber 12 formed therein for receiving a hydraulic oil 13 and for coupling to a hydraulic line 14 which is coupled to a hydraulic brake device (not shown) for braking the bicycle. A piston 20 is slidably received in the chamber 12 of the cylinder housing 10 and provided for forcing the hydraulic oil 13 into the hydraulic line 14 in order to actuate the hydraulic brake device to brake the bicycle. A spring member 21 is also received in the chamber 12 of the cylinder housing 10 and disposed or engaged between the cylinder housing 10 and the piston 20 for biasing the piston 20 out of the chamber 12 of the cylinder housing 10.

The cylinder housing 10 includes a space 15 formed therein, such as formed in the upper portion thereof, and formed or defined between two flaps 16 and communicating with the chamber 12 of the cylinder housing 10. A level handle 30 includes a block 31 formed or provided on one end of the level handle 30, and pivotally or rotatably received or engaged into the space 15 of the cylinder housing 10, and the block 31 includes a middle portion 32 pivotally attached or mounted to the flaps 16 of the cylinder housing 10 with a pivot axle 19 for allowing the level handle 30 to be pivoted or rotated relative to the cylinder housing 10, and for allowing the level handle 30 to be selectively pulled toward the handlebar 80 by the user and to be moved away from the handlebar 80 by the spring member 21 selectively. The above-described structure is typical and will not be described in further details.

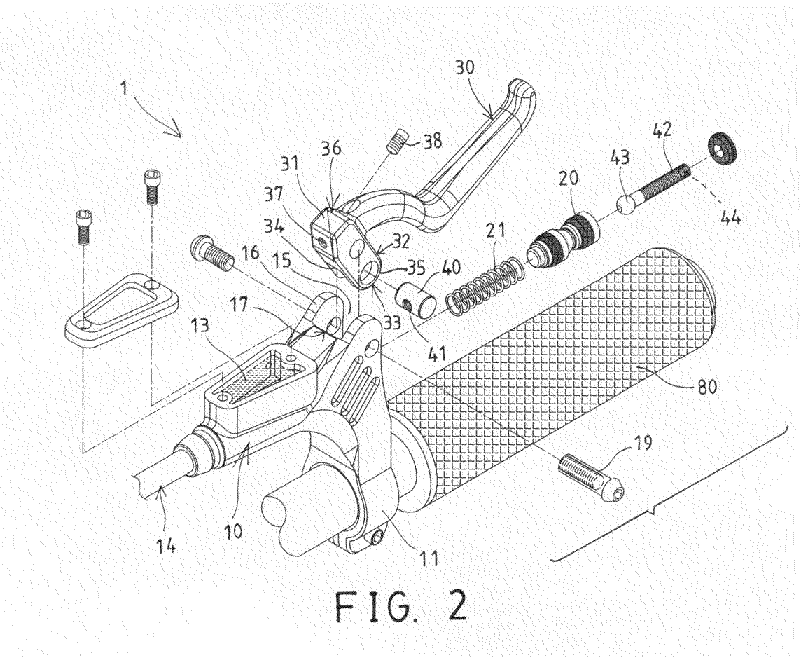

The block 31 includes a lower end or one end or first end 33 having a compartment 34 formed therein and defined between two ears 35, and includes an upper end or the other end or second end 36 having a screw hole 37 formed therein and arranged substantially parallel to the level handle 30 and the piston 20 and the handlebar 80 for threading or engaging with a screw or adjusting member 38. A cross dowel 40 is pivotally or rotatably received or engaged or attached or mounted to the ears 35 and straddled between the ears 35 and extended through the compartment 34 of the block 31, and includes another screw hole 41 formed therein (FIG. 2) and arranged substantially parallel to the level handle 30 and the piston 20 and the handlebar 80 and the screw hole 37 of the block 31 for threading or engaging with a bolt or fastener or actuating member 42 which includes one end 43 for contacting or engaging with the piston 20 and for allowing the actuating member 42 to move or force the piston 20 onto or against the hydraulic oil 13 and the spring member 21.

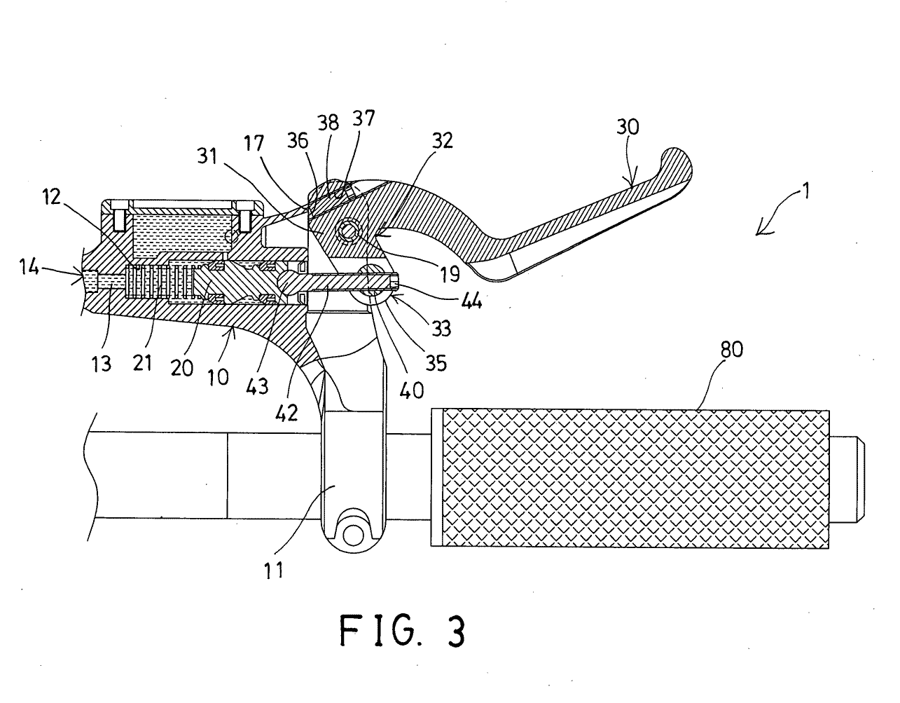

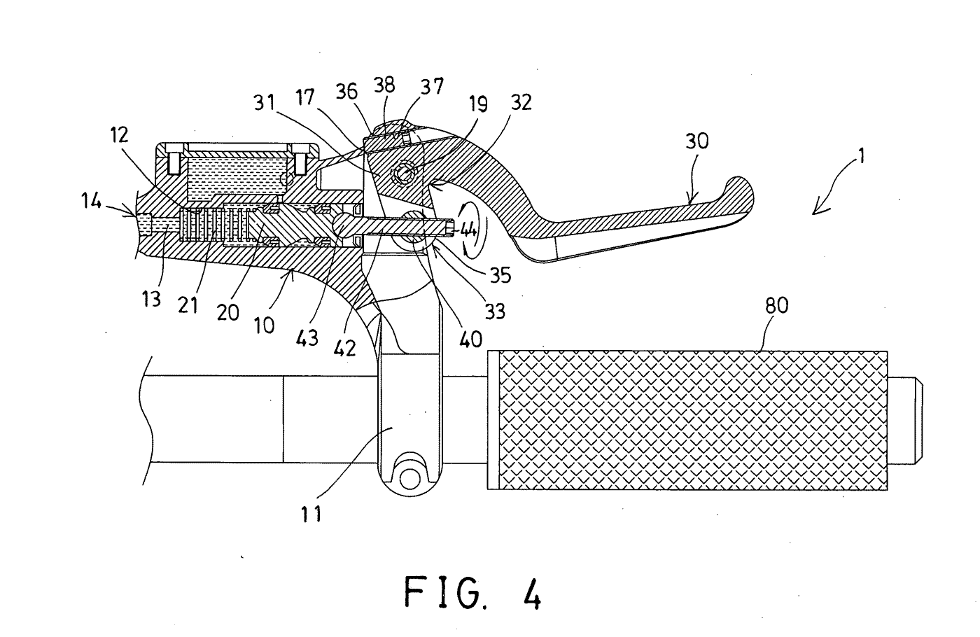

In operation, as shown in FIG. 3, the spring member 21 may bias or force the piston 20 and the actuating member 42 to move out of the chamber 12 of the cylinder housing 10, and may thus pivot or move the level handle 30 away from the handlebar 80 and for allowing the level handle 30 to be readily pulled or actuated or operated by the user. As shown in FIG. 4, the level handle 30 may be pulled toward the handlebar 80 by the user, and the actuating member 42 may be moved to force the piston 20 onto or against the hydraulic oil 13 and the spring member 21 and to force the hydraulic oil 13 into the hydraulic line 14 in order to actuate the hydraulic brake device to brake the bicycle. The actuating member 42 includes a non-circular engaging hole 44 formed in the other end portion thereof for engaging with a driving tool (not shown) which may rotate and adjust the actuating member 42 relative to the cross dowel 40 and to adjust the actuation or operation of the piston 20 by the level handle 30.

The cylinder housing 10 includes an anvil or stop 17 formed or disposed or provided or extended in the space 15 of the cylinder housing 10 and located between the flaps 16, and the upper end or the other end or second end 36 of the block 31 may be engaged with the stop 17 for limiting the movement of the level handle 30 relative to the cylinder housing 10 and for determining the movement between the level handle 30 and the handlebar 80. The threading or rotation of the screw or adjusting member 38 relative to the block 31 of the level handle 30 may move or adjust the adjusting member 38 relative to the block 31 and may selectively and adjustably extend the adjusting member 38 out of the block 31, and the adjusting member 38 may be adjustably engaged with the stop 17 for limiting the movement of the level handle 30 relative to the cylinder housing 10 and for adjustably determining the movement between the level handle 30 and the handlebar 80, and for allowing the level handle 30 to be suitably grasped or gripped and operated by the user.

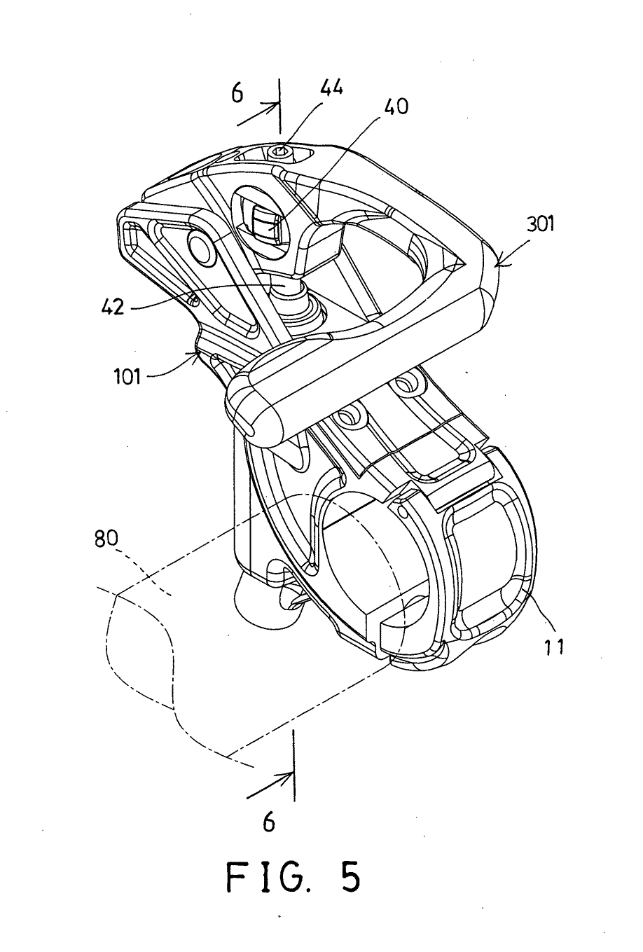

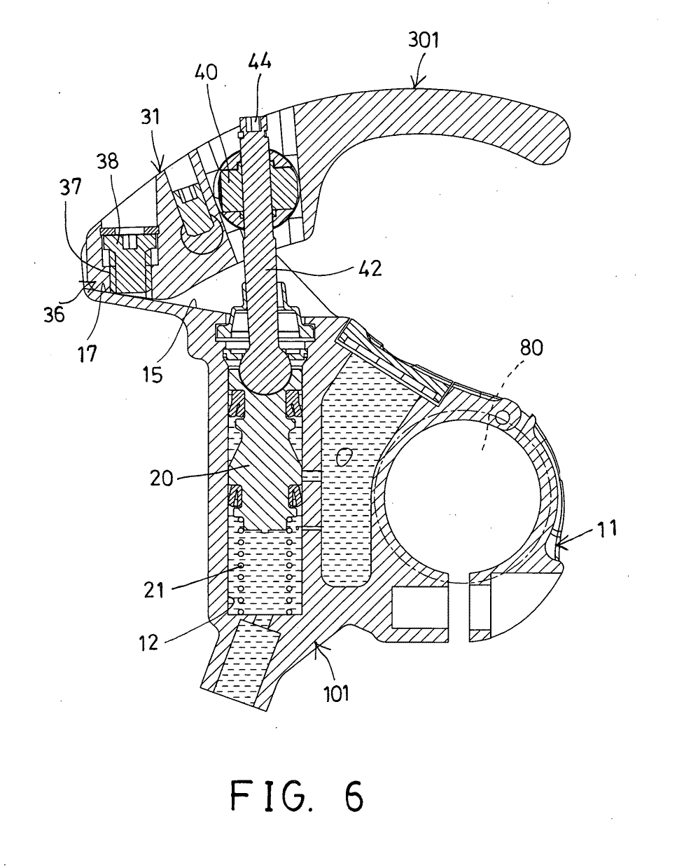

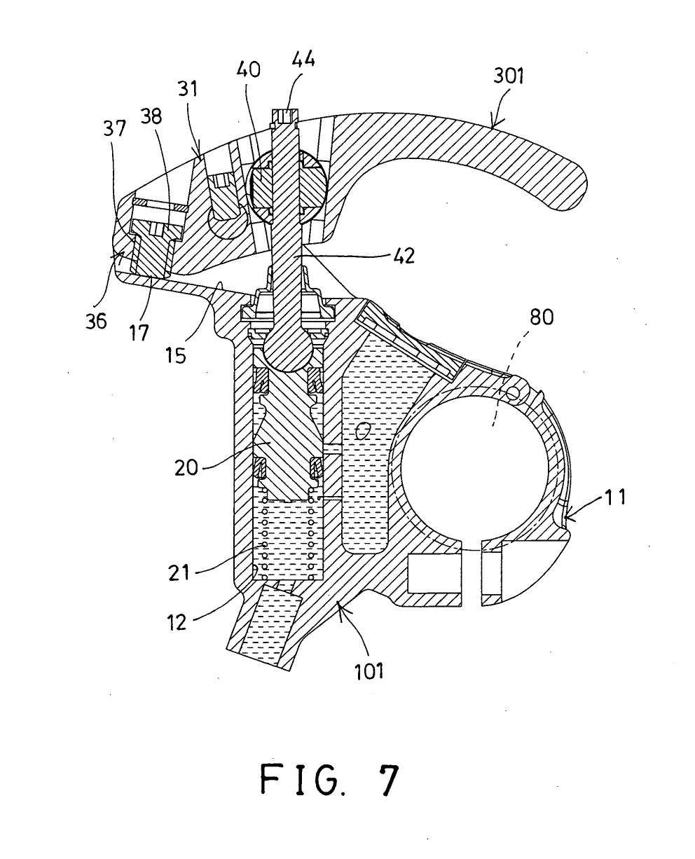

Alternatively, as shown in FIGS. 5-7, the cylinder housing 101 may also be erectly or vertically attached to the handlebar 80 with the bar clamp 11, and includes a space 15 formed therein for pivotally attaching or mounting the block 31 of the level handle 301, and includes a chamber 12 formed therein for slidably receiving a piston 20 and a spring member 21, a cross dowel 40 is also pivotally or rotatably attached or mounted to the block 31 of the level handle 301 for threading or engaging with the actuating member 42 and for adjustably moving or forcing the piston 20 onto or against the spring member 21. A screw or adjusting member 38 is also threaded or engaged with a screw hole 37 of the block 31 of the level handle 301 for adjustably engaging with the stop 17 and for adjustably determining the movement between the level handle 301 and the handlebar 80, and for allowing the level handle 301 to be suitably grasped or gripped and operated by the user.

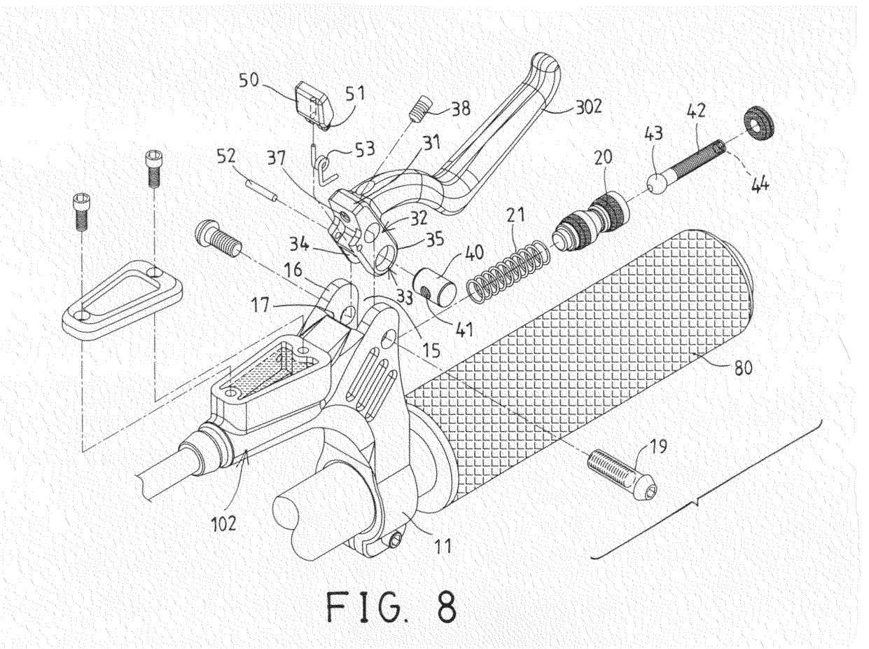

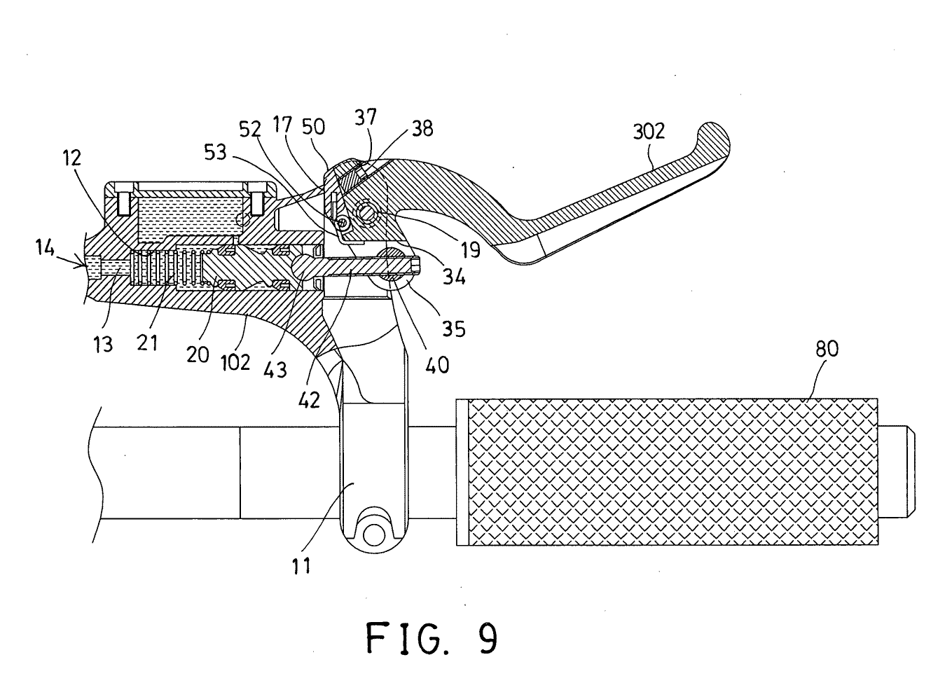

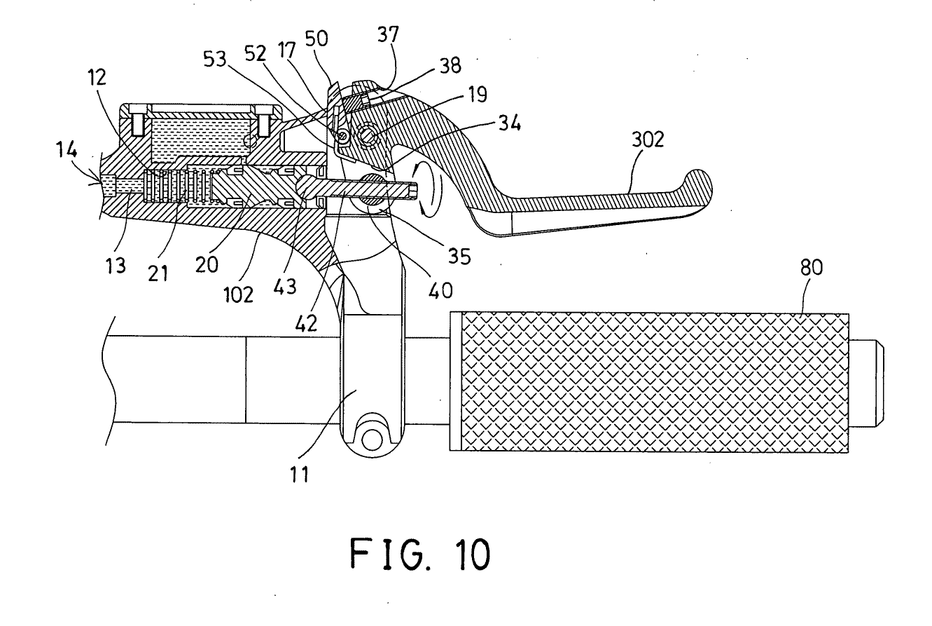

Further alternatively, as shown in FIGS. 8-10, the cylinder housing 102 also includes a chamber 12 formed therein for slidably receiving a piston 20 and a spring member 21, and an anvil or stop 17 formed or disposed or provided or extended in the space 15 of the cylinder housing 102 and located between the flaps 16, and the level handle 302 also includes a block 31, and a pressing member 50 includes one end 51 pivotally or rotatably attached or mounted to the block 31 of the level handle 302 with a pivot shaft 52, and a spring member 53 is attached to the pivot shaft 52 and engaged between the block 31 and the pressing member 50 for biasing the pressing member 50 to press or to engage with the stop 17 of the cylinder housing 102, and the level handle 302 also includes a screw hole 37 formed therein for threading or engaging with a screw or adjusting member 38 which may adjustably extend out of the block 31 for engaging with the pressing member 50 and for adjustably determining the movement between the level handle 302 and the handlebar 80, and for allowing the level handle 302 to be suitably grasped or gripped and operated by the user.

Accordingly, the hydraulic brake lever device in accordance with the present invention includes an adjustable structure for adjusting the distance between the level handle of the hydraulic brake lever device and the handlebar of the bicycle, and for adjusting the braking to the bicycle, and for allowing the level handle of the hydraulic brake lever device to be suitably grasped or gripped and operated by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hydraulic brake lever device comprising:
a cylinder housing for attaching to a handlebar, and including a chamber formed therein for receiving a hydraulic oil and for coupling to a hydraulic line, and including a stop provided on said cylinder housing,
a piston slidably received in said chamber of said cylinder housing and provided for forcing said hydraulic oil into said hydraulic line,
a spring member received in said chamber of said cylinder housing and engaged between said cylinder housing and said piston for biasing said piston out of said chamber of said cylinder housing,
a level handle including a block pivotally attached to said cylinder housing with a pivot axle for allowing said level handle to be pivoted relative to said cylinder housing and for allowing said level handle to be moved toward and away from the handlebar, said block including a first end and a second end, said first end of said block being engageable with said stop of said cylinder housing for determining a movement between said level handle and said handlebar,
an actuating member attached to said second end of said block for engaging with said piston and for selectively moving and forcing said piston onto said hydraulic oil and said spring member, and
an adjusting member threaded to said first end of said block and adjustably extended out of said first end of said block for engaging with said stop of said cylinder housing and for adjusting the movement between said level handle and said handlebar and for allowing said level handle to be suitably operated by a user.

2. The hydraulic brake lever device as claimed in claim 1, wherein said level handle includes a cross dowel pivotally attached to said second end of said block for engaging with said actuating member.

3. The hydraulic brake lever device as claimed in claim 2, wherein said cross dowel includes a screw hole formed therein for threading and engaging with said actuating member.

4. The hydraulic brake lever device as claimed in claim 2, wherein said block includes a compartment formed in said second end of said block and defined between two ears, said cross dowel is pivotally attached to said ears and straddled between said ears and extended through said compartment of said block.

5. The hydraulic brake lever device as claimed in claim 1, wherein said block includes a screw hole formed in said first end of said block for threading and engaging with said adjusting member.

6. The hydraulic brake lever device as claimed in claim 1, wherein said cylinder housing includes a space formed between two flaps and communicating with said chamber of said cylinder housing, said block of said level handle is pivotally attached to said flaps of said cylinder housing with said pivot axle.
